(19) United States
(12) Patent Application Publication
(10) Pub. No.: US 2010/0260194 A1
(43) Pub. Date: Oct. 14, 2010

(54) METHOD, MEDIA GATEWAY CONTROLLER AND MEDIA GATEWAY FOR MEDIA RESOURCE IDENTIFICATION CAPABILITY INTERACTING

(76) Inventor: Yangbo LIN, Shenzhen (CN)

Correspondence Address: Huawei Technologies Co., Ltd./Finnegan, 901 New York Avenue, NW, Washington, DC, 20001, US

(21) Appl. No.: 12/822,980

(22) Filed: Jun. 24, 2010

Related U.S. Application Data
(63) Continuation of application No. PCT/CN2008/073214, filed on Nov. 27, 2008.

(30) Foreign Application Priority Data
Dec. 25, 2007 (CN) 200710301731.X

(51) Int. Cl. H04L 12/56

(52) U.S. Cl. 370/401

(57) ABSTRACT

A method, a media gateway controller (MGC), and a media gateway (MG) for media resource identification capability interacting provide a mechanism for media resource identification capability interacting between the MGC and the MG. Thus, the media resource identification schemes respectively supported by a user and an MG can be exchanged between the MGC and the MG, so as to realize media resource identification capability negotiation between the user and the media provider.

### CROSS-REFERENCE TO RELATED APPLICATIONS

This application is a continuation of International Application No. PCT/CN2008/073214, filed on Nov. 27, 2008, which claims priority to Chinese Patent Application No. 200710301731.X, filed on Dec. 25, 2007, both of which are hereby incorporated by reference in their entireties.

### FIELD OF THE TECHNOLOGY

The present invention relates to the field of communication technologies, and more particularly to a method, a media gateway controller (MGC), and a media gateway (MG) for media resource identification capability interacting.

### BACKGROUND OF THE INVENTION

With the development of communications technologies, the traditional circuit-switching-based public switched telephone network is gradually transitioned to the next generation of packet-switching-based network. The Media Gateway Controller (MGC) and the Media Gateway (MG) are two key components in a Packet Switched Network (PSN) with the architecture that services are separated from bearers. The MGC is responsible for service control while the MG is responsible for media bearing, thereby achieving separation of a service control plane and a media bearing plane. In this way, network resources can be shared fully, device upgrading and service expansion can be simplified, and the development and maintenance cost can be reduced dramatically.

In the real-time media control, the media resources are generally identified by Uniform Resource Identifiers (URIs) or Internationalized Resource Identifiers (IRIs). A URI may be a simple name or a Universal Resource Locator (URL). Based on the differences such as transmission modes, a URL may have many representing solutions, so that various media resource identification manners are currently available.

When studying and practicing the prior art, the inventor found that users and media providers need to know which media resource identification schemes are supported by each other, so as to perform real-time media control successfully. In the architecture that the service is separated from the bearer, the user controls media delivery on the MG through the MGC. Currently, the MGC and the MG are enabled to know the media resource identification schemes supported by both parties merely by means of pre-configuration. Obviously, in such a case, the network does not have desirable commonality to the users.

### SUMMARY OF THE INVENTION

The present invention provides a method, an MGC, and an MG for media resource identification capability interacting, which enable a packet switched network to have desirable commonality in terms of media resource identification in the architecture that an MGC is separated from an MG.

A method for media resource identification capability interacting is provided, which includes the following steps. An MG receives a command request delivered by an MGC, where the command request is configured to deliver to the MG a media resource identification capability requested to be supported; and the MG determines the media resource identification capability that needs to be supported according to the command request from the MGC.

A method for media resource identification capability interacting is provided, which includes the following steps. An MG reports a supported media resource identification capability to an MGC according to a preset triggering event or a command request delivered by the MGC.

An MGC is provided, which includes: a first message sending module, configured to deliver a command request to an MG; and a first capability interacting module, configured to set a media resource identification capability requested to be supported in the command request delivered to the MG.

An MG is provided, which includes: a second message receiving module, configured to receive a command request delivered by an MGC, where the command request is configured to deliver to the MG a media resource identification capability requested to be supported; and a second capability interacting module, configured to determine the media resource identification capability that needs to be supported according to the command request delivered by the MGC.

An MG is provided, which includes: a third message receiving module, configured to receive a command request delivered by an MGC, where the command request is configured to request the MG to report a supported media resource identification capability; a third message sending module, configured to send a command response to the MGC; and a third capability interacting module, configured to set the supported media resource identification capability in the command response sent to the MGC according to the command request delivered by the MGC.

Furthermore, a computer program product is provided, which includes computer program codes. When being executed by a computer, the computer program codes enable the computer to perform the steps of one or all of the above-mentioned methods for media resource identification capability interacting.

Furthermore, a computer readable storage medium is provided, which stores computer program codes. When being executed by a computer, the computer program codes enable the computer to perform the steps of one or all of the above-mentioned methods for media resource identification capability interacting.

In the embodiments of the present invention, a mechanism for media resource identification capability interacting between the MGC and the MG is provided. Thus, the media resource identification schemes respectively supported by a user and the MG can be exchanged between the MGC and the MG, so as to realize media resource identification capability negotiation between the user and the media provider. Therefore, a real-time media control can be performed successfully, so that the packet switched network with the architecture that the MGC is separated from the MG achieves desirable commonality in terms of media resource identification.

### BRIEF DESCRIPTION OF THE DRAWINGS

FIG. 1 is a schematic diagram of networking of an MGC and MGs according to an embodiment of the present invention;

FIG. 2 is a schematic diagram of a logic structure of an MGC according to an embodiment of the present invention;

FIG. 3 is a schematic diagram of a logic structure of an MG according to an embodiment of the present invention; and

FIG. 4 is another schematic diagram of a logic structure of an MG according to an embodiment of the present invention.

### DETAILED DESCRIPTION OF THE EMBODIMENTS

The embodiments of the present invention provide a mechanism for media resource identification capability interacting between an MGC and an MG, so that the media resource identification schemes respectively supported by a user and the MG can be exchanged between the MGC and the MG. The embodiments of the present invention further provide a corresponding MGC and a corresponding MG, which are illustrated respectively in detail below.

FIG. 1 is a schematic diagram of networking of an MGC and MGs according to an embodiment of the present invention. Generally, a packet switched network is established based on the Internet Protocol (IP), the Real-time Transport Protocol (RTP) is adopted in the communications between MGs, and media gateway control protocols are adopted in the communications between the MG and MGC, where the Media Gateway Control Protocol (MGCP) and the Gateway Control Protocol (H.248/MeGaCo) developed from the MGCP are widely adopted currently.

The method for media resource identification capability interacting according to the embodiments of the present invention mainly includes two aspects: The first aspect is that the MGC sets and/or acquires a media resource identification capability on the MG, and the second aspect is that the MG reports a media resource identification capability to the MGC, which are respectively illustrated below.

1. The MGC delivers to the MG a media resource identification capability requested to be supported, and/or requests the MG to report a supported media resource identification capability.

The delivering, by the MGC to the MG, the media resource identification capability requested to be supported may specifically be that the MGC sets a media resource identification scheme that is intended to be supported by the MG, or sets a media resource identification scheme supported by a user. In the capability interacting process of this embodiment, the MGC may perform three types of requesting operations as follows:

□ The MGC only delivers to the MG a media resource identification capability requested to be supported.

This type of requesting operation may be understood as a setting operation, for example, the MGC may set a media resource identification capability to be adopted by the MG according to certain conditions such as situations of media resource identification capabilities of the MG and the user that have been known.

□ The MGC not only delivers to the MG a media resource identification capability requested to be supported, but also requests the MG to report a supported media resource identification capability.

This type of requesting operation has a commonality feature, that is, no matter whether the MGC knows the media resource identification capability of the MG, it can perform capability interacting and matching between the MGC or the user represented by the MGC and the MG through such a process.

□ The MGC only requests the MG to report a supported media resource identification capability.

This type of requesting operation may be understood as a querying operation, which mainly aims at triggering a feedback from the MG.

The MGC may select one or a combination of the three types of requesting operations. Obviously, Type □ includes the function of Type □, so that in actual applications, the MGC may support both the two types or support only one of them. In the case that the MGC only supports Type □, although the request from the MGC includes two aspects, the two aspects may be triggered in combination. For example, one parameter is adopted to trigger the operation of Type □, and the parameter is considered to request for two aspects, that is, it is not only considered to request for what is requested to be supported and is delivered, but also considered to request for reporting.

It should be noted that, in real-time media control, the MG is generally considered as a collection of various resource objects such as so-called “terminations” and “streams” in the H.248 protocol, and such different resource objects may have different media resource identification capabilities, so that all of the above-mentioned requesting operations of the MGC can be performed for specific resource objects, so as to obtain required results pertinently.

2. The MG determines the media resource identification capability that needs to be supported according to the request from the MGC, and/or reports the supported media resource identification capability to the MGC.

The MG may determine the media resource identification capability that needs to be supported based on the above-mentioned Type □ or Type □ of the requesting operations of the MGC. In this case, the MG may take an intersection between supported media resource identification capabilities and media resource identification capabilities to be supported as requested by the MGC to act as the media resource identification capability that needs to be supported. Of course, the MG may further report to the MGC the determined media resource identification capability that needs to be supported.

The reporting operation of the MG may be divided into two types as follows:

□ Active Reporting

This type of operation may be implemented based on a certain triggering condition, for example, at a specific time, periodically, or based on a certain change. In the case that the MG is considered as a collection of various resource objects, the active reporting operation may be performed corresponding to relatively stable resources, for example, an entire MG

□ Passive Feeding Back

This type of operation is performed based on the above-mentioned Type □ or Type □ of the requesting operation of the MGC, and if the request from the MGC is directed to a specific resource object, the MG feeds back a media resource identification capability supported by the specific resource object.

In particular, if the MG feeds back corresponding to the above-mentioned Type □ of the requesting operation of the MGC, the MG may only report the supported media resource identification capability, and may also perform further operations, that is, take the intersection between the supported media resource identification capabilities and the media resource identification capabilities to be supported as requested by the MGC to act as the media resource identification capability that can be supported and report the media resource identification capability, so that the MGC determines the capability matching situation between the MGC or the user represented by the MGC and the MG.

Based on the mechanism for media resource identification capability interacting between the MGC and the MG provided in the embodiments, the media resource identification schemes respectively supported by the user and the MG can be exchanged between the MGC and the MG, so as to realize media resource identification capability negotiation between the user and the media provider. Therefore, a real-time media control can be performed successfully, so that the packet switched network with the architecture that the MGC is separated from the MG achieves a desirable commonality in terms of media resource identification.

The method for media resource identification capability interacting according to the embodiments of the present invention is further described in detail below based on the H.248 protocol.

In the H.248 protocol, various resources on the MG are represented abstractly as terminations. Terminations are divided into physical terminations and ephemeral terminations. The physical terminations represent some semi-permanent physical entities such as timeslots based on Time Division Multiplex (TDM); the ephemeral terminations represent some public resources that are applied temporarily and then released after being used, for example, streams based on the RTP. In addition, a special termination called a Root termination can be utilized to represent the entire MG. The association between terminations is represented abstractly as a Context, which may include a plurality of terminations. Based on the abstract connection model, an interaction between a service and a bearer is actually an operation on Terminations and Context, which is realized by the Request and Reply of the command between the MGC and the MG. The types of the command include Add, Modify, Subtract, Move, AuditCapabilities, AuditValue, Notify, ServiceChange, and the like. The parameters of the command, which are also referred to as Descriptors, may be specifically divided into Property, Signal, Event, Statistics, and the like. For ease of the usage, the parameters having service correlations are aggregated logically into a Package. The control over the MG exercised by the MGC can be directed to the terminations or the streams on the terminations, where a TerminationState descriptor indicates non-stream-specific properties on the terminations; and a LocalControl descriptor indicates stream-related control information.

Based on the H.248 protocol, the media resource identification capability may be represented by expanding a property parameter. The property may be defined in an existing package or a new package. For example, a new package named “Media Resource Identification Scheme Indication package”, abbreviated as mrisi, may be used, and the property is named as “Scheme Type”, abbreviated as st, which is used in the form of “mrisi/st”. The type of the mrisi/st property may be an enumeration type or a character string. If the enumeration type is selected, the value range of the property is relatively constant, and this simplifies the implementing on the MGC and the MG. If the character string type is selected, the value range of the property is relatively random, so that possible character strings between the MGC and the MG need to be stipulated before hand, and it only needs to add stipulation when it intends to expand the value range.

Based on the commonly used media resource identification schemes currently, the value range of the mrisi/st property in the enumeration type is exemplified as follows: file, ftp, http, rtsp, rtsps, rtspu, and name, where each value corresponds to one or more media resource identification schemes:

file—to identify local media resources of the MG in a filename format;

ftp—to identify media resources of other equipments that are not local to the MG in a File Transport Protocol (FTP) format;

http—to identify local media resources of the MG or media resources of other equipments in a HyperText Transfer Protocol (HTTP) format;

rtsp—to identify media resources transferred in a form of streams with a Real-time Streaming Protocol (RTSP) format, where the Transmission Control Protocol (TCP) is adopted for transmission;

rtsps—to identify media resources transferred in the form of streams with an rtsps format, where the Transport Layer Security (TLS) protocol is adopted for transmission;

rtspu—to identify media resources transferred in the form of streams with an rtspu format, where the User Datagram Protocol (UDP) is adopted for transmission; and

Name—to identify media resources with a simple name.

The value range of the mrisi/st property may be any combination of the values described above. Of course, each value of the mrisi/st property may also correspond to more than one media resource identification scheme, for example, rtspx is adopted to represent rtsp, rtsps, and rtspu at the same time.

In addition, if the character string type is adopted, considering the value of the mrisi/st property, the above different enumeration values may be defined as character strings respectively, for making stipulation.

The mrisi/st property is readable and writable. The MGC may set the property to the MG to indicate the media resource identification scheme supported by the user, and the MGC may also acquire the property from the MG to obtain the media resource identification scheme supported by the MG

Based on the expanded mrisi/st property, the method for media resource identification capability interacting between the MGC and the MG is described as follows:

1. The MGC delivers a command request to the MG, where the command request carries an mrisi/st property. Specifically, the MGC delivers to the MG a media resource identification capability requested to be supported through the mrisi/st property carried in the command request, and/or requests the MG to report a supported media resource identification capability.

Based on the functions of various command types in the H.248 protocol, the MGC may carry the mrisi/st property in the request of the command types of Add, Modify, Move, Subtract, AuditValue, or AuditCapabilities, etc., and the property may represent three types of requesting operations as follows:

□ The MGC only delivers to the MG a media resource identification capability requested to be supported.

When the MGC requires the MG to control media through a command request such as Add, Modify, Move, Subtract, and the like, the MGC sets a media resource identification scheme that is intended to be supported by the MG through carrying the mrisi/st property in the command request, or delivers a media resource identification scheme supported by the user to the MG. In such a case, the MGC uses the value of the mrisi/st property to represent the media resource identification capability requested to be supported.

□ The MGC not only delivers to the MG a media resource identification capability requested to be supported, but also requests the MG to report a supported media resource identification capability.

On the basis of Type □, the mrisi/st property representing the media resource identification capability requested to be supported carried in the command request by the MGC also represents requesting the MG to report the media resource identification capability. This type of requesting operation may be understood as follows: The value of the mrisi/st property is considered as the media resource identification capability requested to be supported by the MG; and the “carrying the mrisi/st property” is considered as a request for reporting the supported media resource identification capability by the MG

□ The MGC only requests the MG to report a supported media resource identification capability.

The MGC may set the value of the carried mrisi/st property to “select” indicated by a wildcard “$” in the command request such as Add, Modify, Move, Subtract, and the like, so as to represent that the MGC intends to obtain the media resource identification scheme supported by the MG

The MG may also carry the mrisi/st property in the command request of AuditValue or AuditCapabilities, so as to represent that the MGC requests to audit the media resource identification scheme supported by the MG

Furthermore, the MGC can control specific resource objects on the MG, so that the MGC can apply the mrisi/st property specifically to various resource objects on the MG, including terminations or streams on the terminations and specific media resources on the terminations or the streams. Here, the termination may be a Root termination representing the entire MG, and may be an individual termination in the MG. Based on the parameter structure currently used in the H.248 protocol, if the mrisi/st property is applied to the terminations, the mrisi/st property may be defined in the TerminationState descriptor; if the mrisi/st property is applied to the streams, the mrisi/st property may be defined in the LocalControl descriptor; and if the mrisi/st property is applied to a specific media resource on the terminations or streams, the MGC should also indicate identification information of the media resource to the MG

2. The MG returns a command response corresponding to the received command request to the MGC, and carries the mrisi/st property in the command response, where the value of the property represents the supported media resource identification capability.

Based on the request-response mechanism of the H.248 protocol, the passive feedback situation of the MG is illustrated here.

The command response returned by the MG carries the mrisi/st property, and the value of the property represents the supported media resource identification capability. When the command request from the MGC applies the property to a termination, the MG feeds back all the media resource identification schemes supported by the termination in the command response, where the termination may be a root termination representing the entire MG, or an individual termination in the MG. When the command request from the MGC applies the property to a stream, the MG feeds back all the media resource identification schemes supported by the stream in the command response. When the command request from the MGC applies the property to a termination or a stream, and meanwhile indicates identification information of a specific media resource, the MG feeds back all the media resource identification schemes supported by the specific media resource on the termination or the stream in the command response.

Based on Type □ of the requesting operation of the MGC, exemplary illustrations are given as follows:

### Example 1

An MG receives from an MGC a command request of Add, Modify, Move, or Subtract for a specific resource object, and the command request carries a mrisi/st property with a value of “select” indicated by a wildcard “$”; then, the MG returns a command response corresponding to the command request, carries the mrisi/st property, and feeds back media resource identification schemes supported by the specific resource object to the MGC through the value of the property.

### Example 2

An MG receives from an MGC a command request of AuditValue or AuditCapabilities for a specific resource object, and the command request carries a mrisi/st property representing a request for auditing media resource identification schemes supported by the specific resource object; then, the MG carries the mrisi/st property in a command response returned to the MGC, and feeds back media resource identification schemes supported by the specific resource object to the MGC through the value of the property.

Of course, based on the indication of Type □ of the requesting operation of the MGC, the value of the mrisi/st property such as Add, Modify, Move, or Subtract carried in a command request received by the MG represents the media resource identification schemes requested to be supported by the MG and then, the MG may take an intersection between the media resource identification schemes supported by the MG itself and the media resource identification schemes to be supported as requested by the MGC to act as the supported media resource identification schemes for being reported to the MGC.

Based on the H.248 protocol, another method for representing media resource identification capability is accomplished by expanding a package. Each package corresponds to one or more media resource identification schemes, and if the package is supported, it means that the media resource identification schemes corresponding to the package are also supported.

For example, a new package may be expanded, which is named “RTSP Media Resource Syntax package”, abbreviated as an rtspmrs package. The package has no specific parameters, which represents that RTSP-related URIs, including rtsp, rtsps, and rtspu schemes, are supported. In this case, when the MGC sends a command request of AuditCapabilities directed to a package supporting capability of the termination or the stream to the MG to audit the package supported on the termination or the stream, the MG include the rtspmrs package in a set of supported packages in a corresponding command response returned to the MGC, so as to represent that the termination or the stream on the MG supports the RTSP-related URIs, including rtsp, rtsps, and rtspu schemes. The MGC learns about the media resource identification schemes supported by the corresponding termination or stream on the MG through auditing the package supported by the termination or the stream on the MG

The above embodiments provide a method for media resource identification capability interacting based on the H.248 protocol, which offers a simple and highly efficient resolution for media resource identification capability interacting on the basis of the existing protocol architecture.

An MGC and an MG applied in the above method for media resource identification capability interacting according to the embodiments of the present invention are illustrated below.

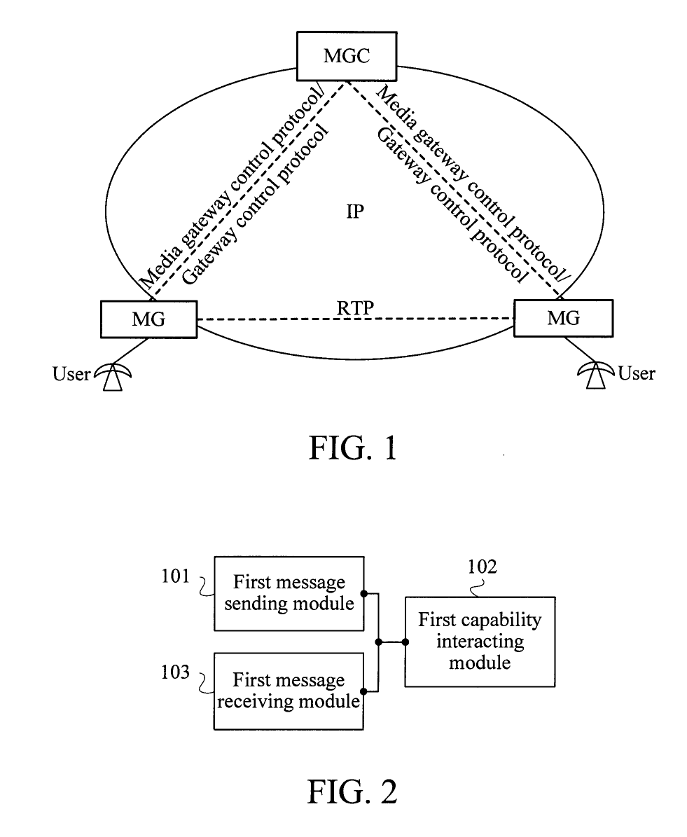

Referring to FIG. 2, a basic logic structure of the MGC according to the embodiment of the present invention includes a first message sending module 101 and a first capability interacting module 102.

The first message sending module 101 is configured to deliver a command request to an MG

The first capability interacting module 102 is configured to set a media resource identification capability requested to be supported in the command request delivered, by the first message sending module 101, to the MG

The MGC may further include a first message receiving module 103.

The first message receiving module 103 is configured to receive a command response from the MG corresponding to the command request sent by the first message sending module 101.

At this time, the first capability interacting module 102 is further configured to obtain supported media resource identification capability reported by the MG from the command response of the MG received by the first message receiving module 103.

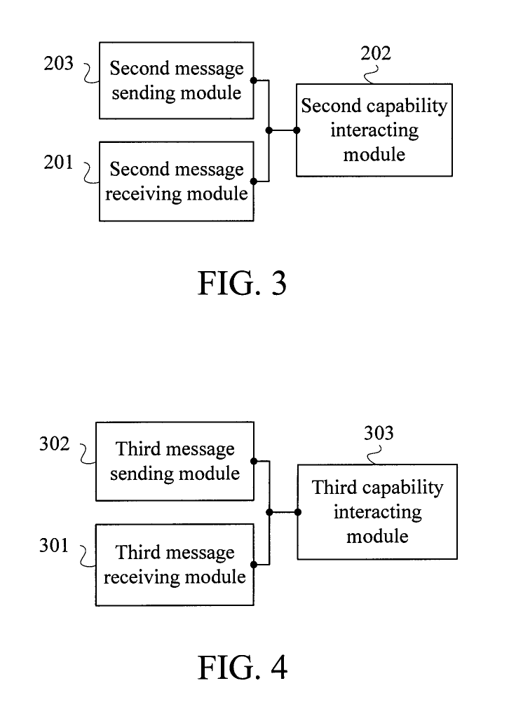

As shown in FIG. 3, a basic logic structure of the MG according to the embodiment of the present invention includes a second message receiving module 201 and a second capability interacting module 202.

The second message receiving module 201 is configured to receive a command request delivered by an MGC, where the command request is configured to deliver to the MG a media resource identification capability requested to be supported.

The second capability interacting module 202 is configured to determine a media resource identification capability that needs to be supported according to the command request delivered by the MGC that is received by the second message receiving module 201.

The MG may further include a second message sending module 203.

The second message sending module 203 is configured to send a command response to the MGC, where the command response carries the media resource identification capability that needs to be supported and that is determined by the second capability interacting module 202.

As shown in FIG. 4, another basic logic structure of the MG according to the embodiment of the present invention includes a third message receiving module 301, a third message sending module 302, and a third capability interacting module 303.

The third message receiving module 301 is configured to receive a command request delivered by an MGC, where the command request is configured to request the MG to report a supported media resource identification capability.

The third message sending module 302 is configured to send a command response to the MGC.

The third capability interacting module 303 is configured to set the supported media resource identification capability in the command response sent by the third message sending module 302 to the MGC according to the command request delivered by the MGC that is received by the third message receiving module 301.

Persons of ordinary skill in the art may understand that all or part of the steps of the method according to the embodiments of the present invention may be implemented by a program instructing relevant hardware. The program may be stored in a computer readable storage medium. The storage medium may be a magnetic disk, a Compact Disk Read-Only Memory (CD-ROM), a Read-Only Memory (ROM) or a Random Access Memory (RAM).

The method, the MGC and the MG for media resource identification capability interacting according to the embodiments of the present invention have been introduced in detail, and specific examples are cited herein to illustrate the principles and the implementation of the present invention, and the illustration of the above embodiments is only intended to facilitate the understanding of the method according to the present invention and the core ideas thereof. Those of ordinary skill in the art can make variations and modifications to the present invention in terms of the specific implementations and application scopes according to the ideas of the present invention. Therefore, the specification shall not be construed as limitations to the present invention.

What is claimed is:

1. A method for media resource identification capability interacting, comprising:
receiving, by a media gateway (MG), a command request delivered by a media gateway controller (MGC), wherein the command request is configured to deliver to the MG a media resource identification capability requested to be supported; and
determining according to the command request from the MGC, by the MG, a media resource identification capability that needs to be supported.

2. The method for media resource identification capability interacting according to claim 1, wherein the determining according to the command request from the MGC, by the MG, the media resource identification capability that needs to be supported further comprises:
taking, by the MG, an intersection between supported media resource identification capabilities and media resource identification capabilities to be supported as requested by the MGC to act as the media resource identification capability that needs to be supported.

3. The method for media resource identification capability interacting according to claim 1, wherein the command request delivered by the MGC is a command request configured to deliver to the MG a media resource identification capability requested to be supported by a specific resource object,
the specific resource object comprises any one of a termination, a stream, or a media resource on the termination or the stream; and the termination is a root termination or an individual termination.

4. The method for media resource identification capability interacting according to claim 1, further comprising:
reporting to the MGC, by the MG, the determined media resource identification capability that needs to be supported.

5. The method for media resource identification capability interacting according to claim 4, wherein
a specific property is carried in the command request delivered by the MGC, values of the property represent media resource identification capabilities, each of the values corresponds to one or more media resource identification schemes, and the media resource identification scheme is any one selected from following schemes or any combination thereof:
a scheme to identify local media resources of an MG in a filename format;
a scheme to identify media resources of other equipments that are not local to the MG in a File Transport Protocol (FTP) format;
a scheme to identify local media resources of the MG or media resources of other equipments in a HyperText Transfer Protocol (HTTP) format;
a scheme to identify media resources transferred in a form of streams with a Real-time Streaming Protocol (RTSP) format, wherein the Transmission Control Protocol (TCP) is adopted for transmission;
a scheme to identify media resources transferred in a form of streams with a Real-time Streaming Protocol (RTSP) format, wherein the Transport Layer Security (TLS) protocol is adopted for transmission;
a scheme to identify media resources transferred in a form of streams with a Real-time Streaming Protocol (RTSP) format, wherein the User Datagram Protocol (UDP) is adopted for transmission; and
a scheme to identify media resources with a simple name; and
the MG determines according to the value of the property the media resource identification capability that needs to be supported.

6. The method for media resource identification capability interacting according to claim 5, wherein the command request delivered by the MGC comprises a command request of Add, Modify, Move, or Subtract.

7. The method for media resource identification capability interacting according to claim 5, wherein the reporting, by the MG, the supported media resource identification capability to the MGC comprises:
returning, by the MG, a command response corresponding to the command request to the MGC, wherein the command response carries the property, and the value of the property represents the supported media resource identification capability.

8. The method for media resource identification capability interacting according to claim 6, wherein the method is accomplished by adopting the H.248 protocol or the Media Gateway Control Protocol.

9. A method for media resource identification capability interacting, comprising:
reporting, by a media gateway (MG), a supported media resource identification capability to a media gateway controller (MGC) according to a preset triggering event or a command request delivered by the MGC.

10. The method for media resource identification capability interacting according to claim 9, wherein the command request delivered by the MGC is a command request configured to request the MG to report a media resource identification capability supported by a specific resource object;
the specific resource object comprises any one of a termination, a stream, or a media resource on the termination or the stream; and the termination is a root termination or an individual termination.

11. The method for media resource identification capability interacting according to claim 10, wherein the command request delivered by the MGC is a command request of Add, Modify, Move, or Subtract carrying a specific property, and a value of the property is a wildcard representing selection and represents requesting the MG to report the supported media resource identification capability.

12. The method for media resource identification capability interacting according to claim 10, wherein the command request delivered by the MGC is a command request of AuditValue or AuditCapabilities carrying a specific property; and through carrying the property, the command request represents requesting the MG to report the supported media resource identification capability.

13. The method for media resource identification capability interacting according to claim 11, wherein the reporting, by the MG, the supported media resource identification capability according to the command request comprises:
returning, by the MG, a command response corresponding to the command request to the MGC, wherein the command response carries the property, and values of the property represent supported media resource identification capabilities, each value of the property representing the media resource identification capability corresponds to one or more media resource identification schemes.

14. The method for media resource identification capability interacting according to claim 12, wherein the reporting, by the MG, the supported media resource identification capability according to the command request comprises:
returning, by the MG, a command response corresponding to the command request to the MGC, wherein the command response carries the property, and values of the property represent supported media resource identification capabilities, each value of the property representing the media resource identification capability corresponds to one or more media resource identification schemes.

15. The method for media resource identification capability interacting according to claim 9, wherein
the command request delivered by the MGC is a command request of AuditCapabilities for a package supporting capability; and
the reporting, by the MG, the supported media resource identification capability according to the command request comprises: returning, by the MG, a command response corresponding to the command request of AuditCapabilities to the MGC, and a supported package carried in the command response represents the supported media resource identification capability, and each type of the package corresponds to one or more media resource identification schemes.

16. A media gateway controller (MGC), comprising:
a first message sending module, configured to deliver a command request to a media gateway (MG); and
a first capability interacting module, configured to set a media resource identification capability requested to be supported in the command request delivered to the M.

17. The MGC according to claim 16, wherein:
the MGC further comprises a first message receiving module, configured to receive a command response of the MG corresponding to the command request sent by the first message sending module; and
the first capability interacting module is further configured to obtain a supported media resource identification capability reported by the MG from the command response of the MG.

18. A media gateway (MG), comprising:
a third message receiving module, configured to receive a command request delivered by a media gateway controller (MGC), wherein the command request is configured to request the MG to report a supported media resource identification capability;
a third message sending module, configured to send a command response to the MGC; and
a third capability interacting module, configured to set the supported media resource identification capability of the MG in the command response sent to the MGC according to the command request delivered by the MGC.
